(19) United States
(12) Patent Application Publication
(10) Pub. No.: US 2021/0146871 A1
(43) Pub. Date: May 20, 2021

(54) MOUNTING BRACKET FOR A CURTAIN AIRBAG

(71) Applicant: ZF Passive Safety Systems US Inc., Washington, MI (US)

(72) Inventors: Richard Patton, Ortonville, MI (US); Avadhoot Paranjpe, Shelby Township, MI (US); Dylan Moran, Rochester Hills, MI (US)

(21) Appl. No.: 16/684,825

(22) Filed: Nov. 15, 2019

(51) Int. Cl. B60R 21/217; B60R 21/232

(52) U.S. Cl. CPC B60R 21/2176; B60R 21/232

(57) ABSTRACT

A mounting bracket for being installed in a mounting tab of a curtain airbag to facilitate connecting the curtain airbag to a vehicle with a fastener includes a plate with a bracket aperture extending therethrough. At least one retainer tab extends radially inward into the bracket aperture from a periphery of the bracket aperture. A free end portion of the at least one retainer tab defines a retainer aperture sized to form an interference fit with the fastener. The at least one retainer tab and the retainer aperture are configured to retain a fastener extending through the mounting tab.

### FIELD OF THE INVENTION

The invention relates to a mounting bracket for being installed in a mounting tab of a curtain airbag to facilitate connecting the curtain airbag to a vehicle with a fastener. The invention further relates to an apparatus for helping to protect an occupant of a vehicle and having means for connecting the apparatus to the vehicle.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that is fixed to the roof of the vehicle and/or to a support structure adjacent to the roof of the vehicle. The inflatable curtain is configured to inflate from the roof of the vehicle downward inside the passenger compartment in the event of a side impact or a vehicle rollover. The inflatable curtain, when inflated, is positioned between a vehicle occupant and the side structure of the vehicle.

There is a constant drive in vehicle manufacturing to cut down on the costs associated with assembling and installing inflatable curtains in vehicles without reducing the effectiveness of the airbags. Reducing the amount of parts required in assembling and installing inflatable curtains can result in a reduction of product and labor costs without a reduction in occupant safety.

### SUMMARY OF THE INVENTION

According to one aspect, a mounting bracket for being installed in a mounting tab of a curtain airbag to facilitate connecting the curtain airbag to a vehicle with a fastener includes a plate with a bracket aperture extending therethrough. At least one retainer tab extends radially inward into the bracket aperture from a periphery of the bracket aperture. A free end portion of the at least one retainer tab defines a retainer aperture sized to form an interference fit with the fastener. The at least one retainer tab and the retainer aperture are configured to retain a fastener extending through the mounting tab.

According to another aspect, alone or in combination with any other aspect, the at least one retainer tab can be resiliently flexible. The at least one resiliently flexible retainer tab can be engageable with a shank of the fastener and deflectable in response to linear insertion of the fastener shank through the retainer aperture. The at least one resiliently flexible retainer tab, when deflected, can engage the shank and inhibit the fastener from being removed from the mounting tab.

According to another aspect, alone or in combination with any other aspect, the free end portion of the at least one retainer tab can be configured to engage threading on a shank of the fastener and prevent the fastener from being removed from the mounting tab.

According to another aspect, alone or in combination with any other aspect, the mounting bracket can comprise four circumferentially spaced retainer tabs. The free end portions of the retainer tabs can have an arcuate configuration so that together the free end portions can define the retainer aperture as having a generally circular configuration.

According to another aspect, alone or in combination with any other aspect, the plate can have a thickness through which the bracket aperture extends. The at least one retainer tab can have a thickness that is less than the thickness of the bracket body.

According to another aspect, alone or in combination with any other aspect, the thickness of the plate can be measured between first and second surfaces of the plate. The at least one retainer tab can be positioned in the bracket aperture at a distance from both the first and second surfaces of the plate.

According to another aspect, alone or in combination with any other aspect, an apparatus for helping to protect an occupant of a vehicle can include the mounting bracket. A curtain airbag can comprise a mounting tab comprising overlying layers of airbag material that define a pocket and through each of which a mounting tab aperture extends. The apparatus can include a fastener for mounting the curtain airbag to the vehicle. The mounting bracket can be positioned in the pocket of the mounting tab. The fastener can have a portion extending through the mounting tab and retainer apertures. The fastener can be retained extending through the mounting tab by the at least one retainer tab and the retainer aperture.

According to another aspect, alone or in combination with any other aspect, a curtain airbag package for installation in a vehicle can include the apparatus and an inflator inserted in a mouth opening of the curtain airbag.

According to another aspect, alone or in combination with any other aspect, both of the plate and the at least one retainer tab can be formed from thermoplastic olefin.

According to another aspect, alone or in combination with any other aspect, the plate and the at least one retainer tab can be formed integrally as one-piece by injection-molding.

According to another aspect, alone or in combination with any other aspect, an apparatus for helping to protect an occupant of a vehicle can include a curtain airbag inflatable from a stored condition in which the curtain airbag is rolled and/or folded to a deployed condition in which the curtain airbag is positioned between a side structure of the vehicle and the vehicle occupant. The curtain airbag can comprise a mounting tab comprising overlying layers of airbag material that define a pocket and through each of which a mounting tab aperture extends. The apparatus can include a fastener for mounting the curtain airbag to the vehicle. The apparatus can include a mounting bracket positioned in the pocket and comprising a plate with a bracket aperture extending therethrough. The mounting bracket can comprise at least one retainer tab extending radially inward into the bracket aperture from a periphery of the bracket aperture. A free end portion of the at least one retainer tab can define a retainer aperture sized to form an interference fit with the fastener. The fastener can have a portion extending through the mounting tab and retainer apertures. The fastener can be retained extending through the mounting tab by the at least one retainer tab and the retainer aperture.

According to another aspect, alone or in combination with any other aspect, wherein the free end portion of the at least one retainer tab can engage threading on a shank of the fastener and prevent the fastener from being removed from the mounting tab.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a schematic side view illustrating an apparatus for helping to protect an occupant of a vehicle;

FIG. 2 is a sectional view of a portion of the apparatus of FIG. 1;

FIG. 3 is a side view of an element of the apparatus of FIG. 1;

FIG. 4 is a sectional view taken along line 4-4 in FIG. 3.

FIG. 5 is a side view of an element of the apparatus of FIG. 1; and

FIG. 6 is a section view of a portion of the apparatus of FIG. 1.

### DETAILED DESCRIPTION OF THE INVENTION

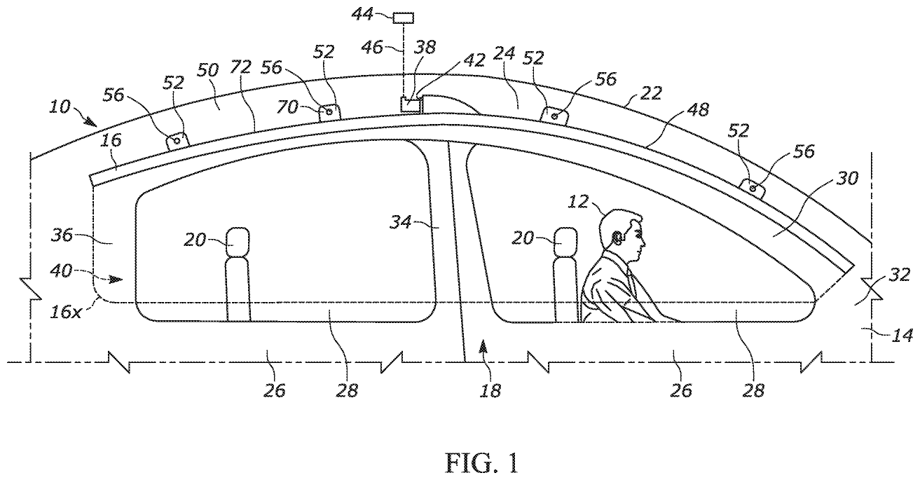

An apparatus 10 for helping to protect an occupant 12 of a vehicle 14 includes an inflatable vehicle occupant protection device 16 in the form of an airbag, such as a curtain airbag, for helping to protect the occupant in the event of a side impact to the vehicle. In the embodiment illustrated in FIG. 1, the curtain airbag 16 is shown on the driver side 18 of the vehicle 14 for helping to protect driver side vehicle occupants. Those skilled in the art will appreciate that the apparatus 10 disclosed herein could be adapted for use on a passenger side (not shown) of the vehicle 14 for helping to protect passenger side vehicle occupants.

The vehicle 14 includes at least one vehicle seat 20 for vehicle occupants 12. The vehicle 14 also includes a vehicle roof 22 and a side structure 24. The vehicle 14 has two rows of seating which help dictate the configuration of the side structure 24. In the example configuration shown in FIG. 1, the side structure 24 of the vehicle 14 includes two vehicle doors 26, two side windows 28, a roof rail 30, an A-pillar 32, a B-pillar 34, and a C-pillar 36. The apparatus 10 can, however, be applied to vehicles having any number of rows, and thus any side structure configuration.

The curtain airbag 16 can be constructed of any suitable material, such as nylon (e.g., woven nylon 6-6 yarns), and can be constructed in any suitable manner. For example, the curtain airbag 16 may have a one-piece woven (OPW) construction in which the curtain airbag is woven as a single piece of material. As another example, the curtain airbag 16 can include more than one piece of material. If more than one piece is used, the pieces can be interconnected by known means, such as stitching, ultrasonic welding, heat bonding, or adhesives, to form the curtain airbag 16. The curtain airbag 16 can be uncoated, coated with a material, such as a gas impermeable urethane, or laminated with a material, such as a gas impermeable film. The curtain airbag 16 thus can have a gas-tight or substantially gas-tight construction. Those skilled in the art will appreciate that alternative materials, such as polyester yarn, and alternatives coatings, such as silicone, can also be used to construct the curtain airbag 16.

An inflator 38 is operably connected to an inflatable volume 40 of the curtain airbag 16 in any known manner. In the example configuration of FIG. 1, the inflator 38 is inserted in a mouth opening 42 of the curtain airbag. The inflator 38 is actuatable to provide inflation fluid to the inflatable volume 40 of the curtain airbag 16 to inflate and deploy the curtain airbag from a stored condition, indicated by solid lines at 16 in FIG. 1, to a deployed condition, indicated by dashed lines at 16x in FIG. 1. The inflator 38 can be of any known type, such as stored gas, solid propellant, augmented, or hybrid. An airbag controller 44 can be operatively connected to the inflator 38 via lead wires 46. The airbag controller 44 is configured to actuate the inflator 38 in response to sensing the occurrence of an event for which occupant protection is desired, such as a collision.

As shown in the example configuration of FIG. 1, the curtain airbag 16 and the inflator 38 are mounted as a package 48 to a support structure 50 of the vehicle 14. At least a portion of the curtain airbag 16 is rolled and/or folded and contained in the support structure 50 when the curtain airbag is in the stored condition. The curtain airbag 16 is inflatable and deployable by the inflator 38 from the stored condition away from the support structure 50 and toward the deployed condition. In the deployed condition, the curtain airbag 16 is positioned between the side structure 24 and the vehicle occupant 12. The support structure 50 can be any structure in the vehicle 14 that will accommodate the curtain airbag 16 being deployed therefrom so that the deployed curtain airbag is positioned between the side structure 24 and the vehicle occupant 12. In the example configuration shown in FIG. 1, the support structure 50 is the roof rail 30.

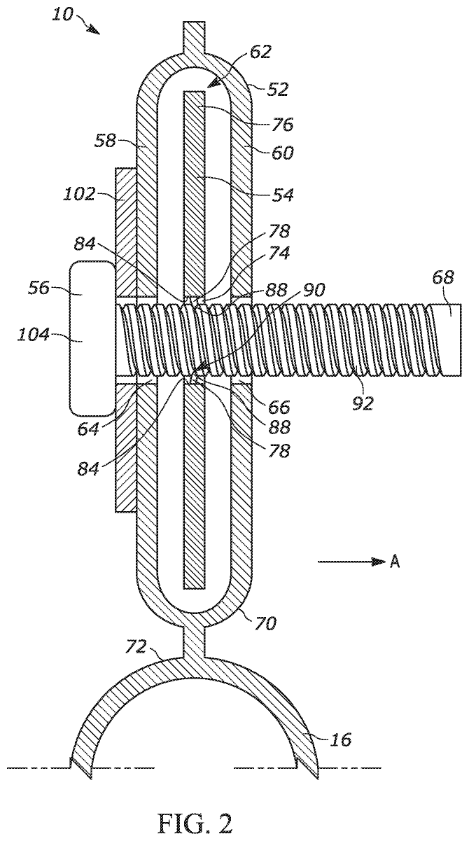

As shown in FIGS. 1-2, the curtain airbag 16 includes at least one mounting tab 52 configured to receive a mounting bracket 54 and a fastener 56 for securing the curtain airbag and the mounting bracket to the roof rail 30. The mounting tab 52 has a two layer configuration in which first and second overlying layers 58, 60 are interconnected to define a pocket 62 that receives the mounting bracket 54. The first and second layers 58, 60 each include a mounting tab aperture 64, 66 having a diameter sufficient to permit a shank 68 of the fastener 56 to pass through the mounting tab 52 freely.

The mounting tab 52 is formed from a piece of airbag fabric 70 that extends from an upper edge 72 of the curtain airbag 16. For a multi-piece sewn construction of the curtain airbag 16, this piece of airbag fabric 70 can be formed integrally with an airbag panel or can be a separate piece connected to the curtain airbag, such as by stitching. The airbag fabric extension 70 can be folded over and interconnected (e.g., by stitching) to define the overlying layers 58, 60 and the pocket 62. For a one-piece woven (OPW) construction of the curtain airbag 16, the mounting tab 52 can be formed as an integral portion of the OPW construction in which the overlying layers 58, 60 are woven simultaneously and interwoven to define the pocket 62.

In the example configuration illustrated in FIG. 2, the mounting tab 52 is formed as an integral portion of the OPW curtain airbag 16. The mounting tab apertures 64, 66 in the first and second overlying layers 58, 60 permit the fastener shank 68 to pass through both the mounting tab 52 and a bracket aperture 74 in the mounting bracket 54 when the mounting bracket is positioned in the pocket 62. The mounting bracket 54 can have one or more fastener retaining structures that are configured to retain the shank 68 and thereby secure the fastener 56, once inserted, in the mounting tab 52. The fastener 56, being retained in the mounting tab 52 and passing through the bracket aperture 74, also retains the mounting bracket 54 in the pocket 62.

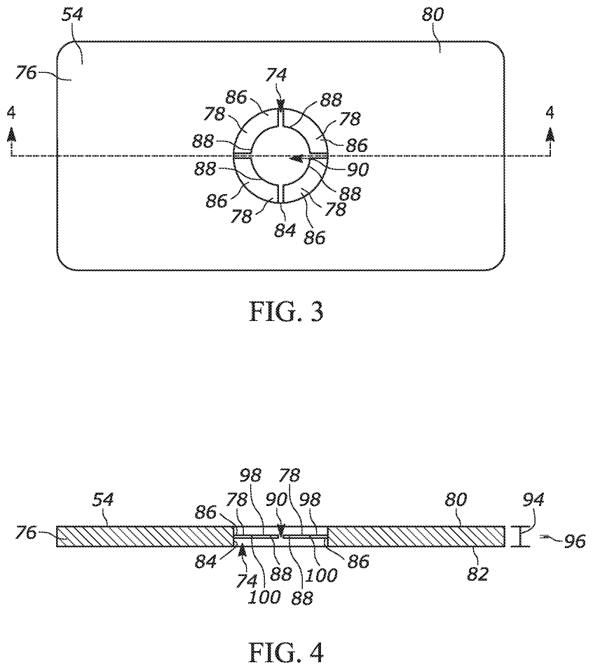

Advantageously, the configuration of the mounting bracket 54 allows for the elimination of additional mechanical fastening devices, such as push nuts or retaining washers, for retaining the fastener 56 in the mounting tab 52. As shown in the example configuration of FIG. 3, the mounting bracket 54 comprises a plate 76 with the bracket aperture 74 extending therethrough. One or more retainer tabs 78 are positioned in the bracket aperture 74 at a distance from both first and second surfaces 80, 82 of the plate 76. The one or more retainer tabs 78 extend radially inward into the bracket aperture 74 from a periphery 84 of the bracket aperture. The one or more retainer tabs 78 thus have a merged end portion 86 that is merged with the bracket aperture periphery 86 and a free end portion 88 that is spaced apart, or free, from the bracket aperture periphery.

The retainer tab(s) 78 can be formed integrally with the plate 76 as one-piece, such as by injection molding. Alternatively, a solid plate 76 can be provided and then the bracket aperture 74 and retainer tab(s) 78 can be formed by milling, cutting, carving, and/or etching the solid plate. As another alternative, the retainer tab(s) 78 can be formed separate from the plate 76 and then bonded to the bracket aperture periphery 84. As another alternative, the retainer tab(s) 78 can be formed, and then the plate 76 can be formed by being overmolded around the formed retainer tab(s).

The free end portion 88 of the one or more retainer tabs 78 define a retainer aperture 90 in the bracket aperture 74. In the example configuration shown in FIG. 3, four retainer tabs 78 are circumferentially spaced along the bracket aperture periphery 84. The free end portions 88 of the retainer tabs 78 are arcuate so that together they define the retainer aperture 90 as having a generally circular configuration. The retainer aperture 90 has a diameter selected to form an interference with the fastener shank 68. The interference can be small or slight, so that installation of the fastener 56 does not damage the retainer tabs 78. The interference needs only to be sufficient to hold the fastener 56 in the mounting tab 52 during installation of the curtain airbag package 48. The shank 68 can be installed through the retainer aperture 90 without damaging the retainer tabs 78 because 1) the fastener shank is threaded 92 and, because those threads are helical, the interference can be overcome by manually twisting, wiggling, etc. while applying an axial installation force to the fastener 56, and/or 2) the retainer tabs can be configured to deflect to permit the passage of the shank.

The retainer tabs' 78 ability to deflect can be the result of the retainer tabs' structure and/or material composition. As discussed above, each of the retainer tabs 78 is merged with, and thus supported by, the remainder of the mounting bracket 54 only at the merged end portion 86. Because of this configuration, the free end portions 88 are able to pivot upward/downward, in the orientation of FIG. 4, with respect to the remainder of the mounting bracket 54. Pivoting the free end portions 88 causes the retainer tabs 78 to be deflected from a non-deflected position (FIG. 4) to a deflected position (FIG. 2). The retainer tabs 78 can be deflected from the non-deflected position to the deflected position upon linear insertion of the shank 68 through the retainer aperture 90 because the axial insertion force of the passing shank can cause the free end portions 88 of the retainer tabs to pivot in an insertion direction.

The thickness of the retainer tabs 78 can also contribute to the retainer tabs' ability to deflect relative to the remainder of the mounting bracket 54. As shown in FIG. 4, the plate 76 of the mounting tab 52 has a thickness 94, measured between the first and second surfaces 80, 82 of the plate, through which the bracket aperture 74 extends. The retainer tabs 78 have a thickness 96, measured between first and second surfaces 98, 100 of the retainer tabs, that is less than the thickness 94 of the plate 76. As a result of the retainer tabs 78 being less thick than the plate 76, the axial insertion force of the shank 68 being inserted through the retainer aperture 90 is able to cause the retainer tabs to deflect without causing the plate to significantly flex, deflect, and/or deform.

The retainer tabs 78 can also be configured to deflect relative to the remainder of the mounting bracket 54 as a result of the material(s) selected to construct the mounting bracket. The mounting bracket 54, and thus the retainer tabs 78, can be formed from a resiliently flexible material, such as thermoplastic olefin. Forming the retainer tabs 78 from a resiliently flexible material permits the retainer tabs to deflect under the axial insertion force of the shank 68 without breaking off from the plate 76 and/or being permanently deformed.

Advantageously, because the plate 76 is formed from a resiliently flexible material, the mounting bracket 54 is able to absorb deployment forces of the curtain airbag 16, such as by deforming or flexing in response to the deployment forces, to reduce deployment force caused stress on the airbag fabric 70 at the mounting tab 52.

Referring to FIG. 2, when the fastener 56 is installed, the shank 68 linearly passes through the mounting aperture 64 in the first overlying layer 58 and the mounting aperture 66 of the second overlying layer 60. The shank 68 also linearly passes through the pocket 62 and the retainer aperture 90 of the mounting bracket 54 positioned therein. The retainer tabs 78 engage the threading 92 of the shank 68 and can deflect in an insertion direction in response to the linear insertion of the shank through the retainer aperture 90. As shown in FIG. 2, the retainer tabs 78 can remain deflected in the insertion direction, as indicated by an arrow “A”, after the fastener 56 has been installed in the mounting tab 52. The retainer tabs 78, being deflected in the insertion direction, can help to limit and/or prevent the installed fastener 56 from moving opposite to the insertion direction, and thus from being removed from the mounting tab 52.

Regardless of whether the retainer tabs 78 remain deflected or return to the non-deflected position after the fastener 56 has been installed in the mounting tab 52, the retainer aperture 90 forms an interference with the fastener shank 68. This interference is the result of the retainer tabs 78 being sized so that the free end portions 88 engage the shank threading 92 of an installed fastener 56. The engagement between the free end portions 88 and the shank threading 92 limits and/or prevents the fastener 56 from being removed from the mounting tab 52, and thus holds the fastener in the mounting tab during installation of the curtain airbag package 48.

As shown in FIG. 2, a washer 102 can also be installed between the mounting tab 52 and a head 104 of the fastener 56. In this installed condition, the retainer tabs and aperture 78, 90 not only retains the fastener 56 in the mounting tab 52, it also retains the mounting bracket 54 in the pocket 62 and the washer 102 on the fastener.

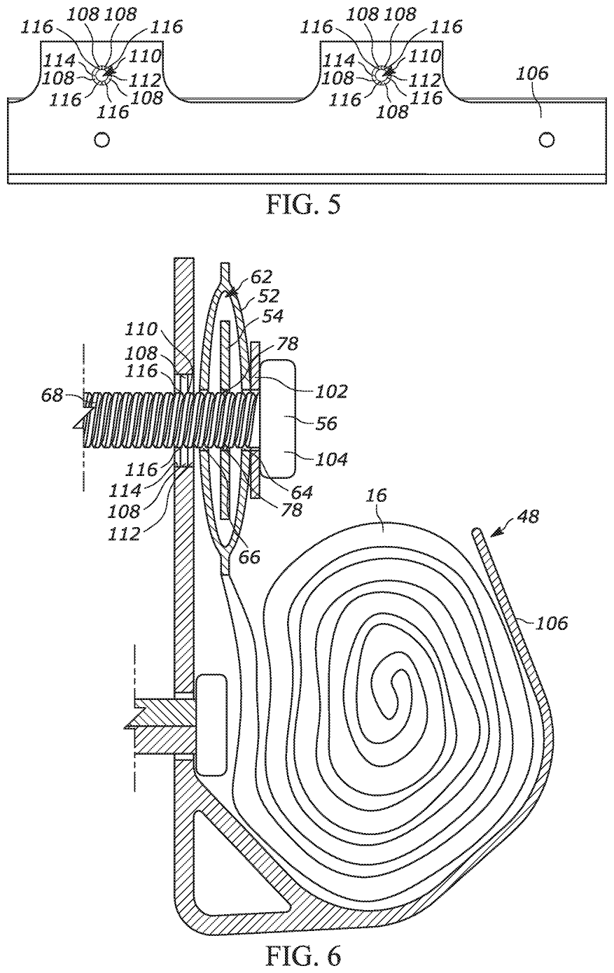

Although the retainer tabs and aperture 78, 90 have been shown as being integrated in the mounting bracket 54, the retainer tabs and aperture can also be integrated in other components of the curtain airbag package 48, such as in deployment controlling ramps and in shape maintainers that maintain the curtain airbag rolled and/or folded. FIGS. 5-6 depict a deployment controlling ramp 106 for the curtain airbag 16 having one or more retainer tabs 108 integrated therein that define a retainer aperture 110. The one or more retainer tabs 108 of the deployment controlling ramp 106 can have a similar configuration to those shown in FIGS. 2-4. Thus, as shown in the example configuration of FIGS. 5-6, four retainer tabs 108 are circumferentially spaced in a ramp aperture 112 along the periphery 114 of the ramp aperture. The retainer tabs 108 extend radially inward into the ramp aperture 112 from the ramp aperture periphery 114. Free end portions 116 of the retainer tabs 108 can be arcuate so that together they can define the retainer aperture 110 as having a generally circular configuration.

The retainer aperture 110 of the deployment controlling ramp 106 has a diameter selected to form an interference with the fastener shank 68 to hold the fastener 56 in the mounting tab 52 and in the deployment controlling ramp during installation of the curtain airbag package 48. Similarly to that described above, the shank 68 can be installed through the retainer aperture 110 of the deployment controlling ramp 106 without damaging the retainer tabs 108 because 1) the fastener shank is threaded 92 and, because those threads are helical, the interference can be overcome by manually twisting, wiggling, etc. while applying an axial installation force to the fastener 56, and/or 2) the retainer tabs can be configured to deflect to permit the passage of the shank.

Although the curtain airbag package 48 in FIGS. 5-6 depicts the use of the mounting bracket 54 of FIGS. 2-4 holding the fastener 56 in the mounting tab 52 in conjunction with the deployment controlling ramp 106 of FIGS. 5-6, it should be appreciated that a mounting bracket having no retainer tabs or aperture 78, 90 can instead be utilized with the deployment controlling ramp of FIGS. 5-6. In such configuration, the retainer tabs and aperture 108, 110 of the deployment controlling ramp 106 not only retain the fastener 56 in the mounting tab 52, they also retain the fastener in the deployment controlling ramp, the mounting bracket 54 in the pocket 62, and the washer 102, when provided, on the fastener.

From the above description of the invention, those skilled in the art will perceive improvements, changes and modifications. Such improvements, changes and modifications within the skill of the art are intended to be covered by the appended claims.

Having described the invention, the following is claimed:

1. A mounting bracket for being installed in a mounting tab of a curtain airbag to facilitate connecting the curtain airbag to a vehicle with a fastener, the mounting bracket comprising:
a plate with a bracket aperture extending therethrough; and
at least one retainer tab extending radially inward into the bracket aperture from a periphery of the bracket aperture, a free end portion of the at least one retainer tab defining a retainer aperture sized to form an interference fit with the fastener;
wherein the at least one retainer tab and the retainer aperture are configured to retain a fastener extending through the mounting tab.

2. The mounting bracket of claim 1, wherein the at least one retainer tab is resiliently flexible, the at least one resiliently flexible retainer tab being engageable with a shank of the fastener and deflectable in response to linear insertion of the fastener shank through the retainer aperture, the at least one resiliently flexible retainer tab, when deflected, engaging the shank and inhibiting the fastener from being removed from the mounting tab.

3. The mounting bracket of claim 1, wherein the free end portion of the at least one retainer tab is configured to engage threading on a shank of the fastener and prevent the fastener from being removed from the mounting tab.

4. The mounting bracket of claim 1, wherein the mounting bracket comprises four circumferentially spaced retainer tabs, the free end portions of the retainer tabs having an arcuate configuration so that together the free end portions define the retainer aperture as having a generally circular configuration.

5. The mounting bracket of claim 1, wherein the plate has a thickness through which the bracket aperture extends, and wherein the at least one retainer tab has a thickness that is less than the thickness of the bracket body.

6. The mounting bracket of claim 5, wherein the thickness of the plate is measured between first and second surfaces of the plate, and wherein the at least one retainer tab is positioned in the bracket aperture at a distance from both the first and second surfaces of the plate.

7. An apparatus for helping to protect an occupant of a vehicle, comprising:
the mounting bracket recited in claim 1;
a curtain airbag comprising a mounting tab comprising overlying layers of airbag material that define a pocket and through each of which a mounting tab aperture extends; and
a fastener for mounting the curtain airbag to the vehicle;
wherein the mounting bracket is positioned in the pocket of the mounting tab;
wherein the fastener has a portion extending through the mounting tab and retainer apertures, the fastener being retained extending through the mounting tab by the at least one retainer tab and the retainer aperture.

8. A curtain airbag package for installation in a vehicle, comprising:
the apparatus recited in claim 7; and
an inflator inserted in a mouth opening of the curtain airbag.

9. The mounting bracket of claim 1, wherein both of the plate and the at least one retainer tab are formed from thermoplastic olefin.

10. The mounting bracket of claim 1, wherein the plate and the at least one retainer tab are formed integrally as one-piece by injection-molding.

11. An apparatus for helping to protect an occupant of a vehicle, comprising:
a curtain airbag inflatable from a stored condition in which the curtain airbag is rolled and/or folded to a deployed condition in which the curtain airbag is positioned between a side structure of the vehicle and the vehicle occupant, the curtain airbag comprising a mounting tab comprising overlying layers of airbag material that define a pocket and through each of which a mounting tab aperture extends;
a fastener for mounting the curtain airbag to the vehicle; and
a mounting bracket positioned in the pocket and comprising a plate with a bracket aperture extending therethrough, the mounting bracket comprising at least one retainer tab extending radially inward into the bracket aperture from a periphery of the bracket aperture, a free end portion of the at least one retainer tab defining a retainer aperture sized to form an interference fit with the fastener;
wherein the fastener has a portion extending through the mounting tab and retainer apertures, the fastener being retained extending through the mounting tab by the at least one retainer tab and the retainer aperture.

12. The apparatus of claim 11, wherein the at least one retainer tab is resiliently flexible, the at least one resiliently flexible retainer tab being engageable with a shank of the fastener and deflectable in response to linear insertion of the fastener shank through the retainer aperture, the at least one resiliently flexible retainer tab, when deflected, engaging the shank and inhibiting the fastener from being removed from the mounting tab.

13. The apparatus of claim 11, wherein the free end portion of the at least one retainer tab engages threading on a shank of the fastener and prevents the fastener from being removed from the mounting tab.

14. The apparatus of claim 11, wherein the mounting bracket comprises four circumferentially spaced retainer tabs, the free end portions of the retainer tabs having an arcuate configuration so that together the free end portions define the retainer aperture as having a generally circular configuration.

15. The mounting bracket of claim 11, wherein the plate has a thickness through which the bracket aperture extends, and wherein the at least one retainer tab has a thickness that is less than the thickness of the bracket body.

16. The mounting bracket of claim 15, wherein the thickness of the plate is measured between first and second surfaces of the plate, and wherein the at least one retainer tab is positioned in the bracket aperture at a distance from both the first and second surfaces of the plate.

17. A curtain airbag package for installation in a vehicle, comprising:
the apparatus recited in claim 11;
an inflator inserted in a mouth opening of the curtain airbag.
